(19) United States
(12) Patent Application Publication
(10) Pub. No.: US 2022/0246913 A1
(43) Pub. Date: Aug. 4, 2022

(54) ANODE ACTIVE MATERAL LAYER

(71) Applicant: TOYOTA JIDOSHA KABUSHIKI KAISHA, Toyota-shi (JP)

(72) Inventor: Hiroshi NAGASE, Nogoya-shi (JP)

(21) Appl. No.: 17/648,234

(22) Filed: Jan. 18, 2022

(30) Foreign Application Priority Data
Feb. 4, 2021 (JP) 2021-016360

(51) Int. Cl. H01M 4/36; H01M 10/0525; H01M 10/0585; H01M 4/485

(52) U.S. Cl. CPC H01M 4/364; H01M 10/0525; H01M 2004/027; H01M 4/485; H01M 10/0585

(57) ABSTRACT

A main object of the present disclosure is to provide an anode active material layer with low resistance. The present disclosure achieves the object by providing an anode active material layer to be used in an all solid state battery, the anode active material layer comprises: a first anode active material and a second anode active material; wherein the first anode active material is a lithium titanate; in the second anode active material, when a discharge capacity at a potential of 1.0 V vs Li⁺/Li or more and 2.0 V vs Li⁺/Li or less signifies 100% discharge capacity, and when P₁ designates an average potential in a capacity of 0% or more and 50% or less of the 100% discharge capacity, and P₂ designates an average potential in a capacity of 50% or more and 100% or less of the 100% discharge capacity, a difference between the P₂ and the P₁ is 0.1 V or more; and a proportion of the first anode active material with respect to a total of the first anode active material and the second anode active material is 40 volume % or more.

### TECHNICAL FIELD

The present disclosure relates to an anode active material layer to be used in an all solid state battery.

### BACKGROUND ART

An all solid state battery is a battery including a solid electrolyte layer between a cathode active material layer and an anode active material layer, and one of the advantages thereof is that the simplification of a safety device may be more easily achieved compared to a liquid-based battery including a liquid electrolyte containing a flammable organic solvent.

As an anode active material, lithium titanate has been known. For example, Patent Literature 1 discloses an all solid state battery using a lithium titanate sintered body as a cathode or an anode. Also, Patent Literature 2 discloses an all solid state battery comprising an anode active material layer including a first layer and a second layer, wherein the second layer contains a lithium titanate. Also, although it is not a technology relating to an all solid state batter, Patent Literature 3 discloses an electrode group wherein an anode active material layer contains a titanium-containing oxide.

### CITATION LIST

### Patent Literatures

Patent Literature 1: Japanese Patent Application Laid-Open (JP-A) No. 2015-185337
Patent Literature 2: JP-A No. 2020-174004
Patent Literature 3: JP-A No. 2019-053946

### SUMMARY OF DISCLOSURE

### Technical Problem

In a lithium titanate, as described later, the ratio occupied with a plateau region is large in charge and discharge curves. Therefore, when the lithium titanate is used as an anode active material, electrode reactions tend to deviate in the thickness direction of the anode active material layer, and as a result, the resistance tends to increase.

The present disclosure has been made in view of the above circumstances and a main object thereof is to provide an anode active material layer with low resistance.

### Solution to Problem

In order to achieve the object, the present disclosure provides an anode active material layer to be used in an all solid state battery, the anode active material layer comprises: a first anode active material and a second anode active material; wherein the first anode active material is a lithium titanate; in the second anode active material, when a discharge capacity at a potential of 1.0 V vs Li⁺/Li or more and 2.0 V vs Li⁺/Li or less signifies 100% discharge capacity, and when P₁ designates an average potential in a capacity of 0% or more and 50% or less of the 100% discharge capacity, and P₂ designates an average potential in a capacity of 50% or more and 100% or less of the 100% discharge capacity, a difference between the P₂ and the P₁ is 0.1 V or more; and a proportion of the first anode active material with respect to a total of the first anode active material and the second anode active material is 40 volume % or more.

According to the present disclosure, the first anode active material that is the lithium titanate is used together with the specified second anode active material, and the proportion of the first anode active material is the specified value or more, and thus the anode active material layer with low resistance may be obtained.

In the disclosure, a discharge capacity of the second anode active material at a potential of 1.4 V vs Li⁺/Li or more and 2.0 V vs Li⁺/Li or less may be 100 mAh/g or more.

In the disclosure, the second anode active material may be at least one of a niobium-titanium oxide and a niobium-tungsten oxide.

In the disclosure, the proportion of the first anode active material with respect to the total of the first anode active material and the second anode active material may be 90 volume % or less.

The present disclosure also provides an all solid state battery comprising a cathode active material layer, an anode active material layer, and a solid electrolyte layer arranged between the cathode active material layer and the anode active material layer; wherein the anode active material layer is the above described anode active material layer.

According to the present disclosure, usage of the above described anode active material layer allows the all solid state battery to have low resistance.

### Advantageous Effects of Disclosure

The present disclosure exhibits an effect of providing an anode active material layer with low resistance.

### BRIEF DESCRIPTION OF DRAWINGS

FIG. 1 is charge and discharge curves of a half cell using a LTO as a working electrode, and a Li foil as a counter electrode.

FIGS. 2A to 2D are schematic cross-sectional views illustrating the state change of the anode active material layer containing the LTO in a charged state.

FIG. 3 is charge and discharge curves of a half cell using a TNO as a working electrode, and a Li foil as a counter electrode.

FIG. 4 is a schematic cross-sectional view exemplifying the all solid state battery in the present disclosure.

FIG. 5 is the result of resistance measurements for all solid state batteries obtained in Examples 1 to 4 and Comparative Examples 1 to 3.

### DESCRIPTION OF EMBODIMENTS

The anode active material layer and the all solid state battery in the present disclosure are hereinafter explained in details.

A. Anode Active Material Layer

The anode active material layer in the present disclosure is used in an all solid state battery, and contains a first anode active material and a second active material. Also, the anode active material layer contains a first anode active material and a second anode active material. The first anode active material is a lithium titanate. In the second anode active material layer, when a discharge capacity at a potential of 1.0 V vs Li⁺/Li or more and 2.0 V vs Li⁺/Li or less signifies 100% discharge capacity, and when P₁ designates an average potential in a capacity of 0% or more and 50% or less of the 100% discharge capacity, and P₂ designates an average potential in a capacity of 50% or more and 100% or less of the 100% discharge capacity, a difference between the P₂ and the P₁ is 0.1 V or more. Further, in the anode active material layer, the proportion of the first anode active material with respect to the total of the first anode active material and the second anode active material is 40 volume % or more.

According to the present disclosure, the first anode active material that is the lithium titanate is used together with the specified second anode active material, and the proportion of the first anode active material is the specified value or more, and thus the anode active material layer with low resistance may be obtained.

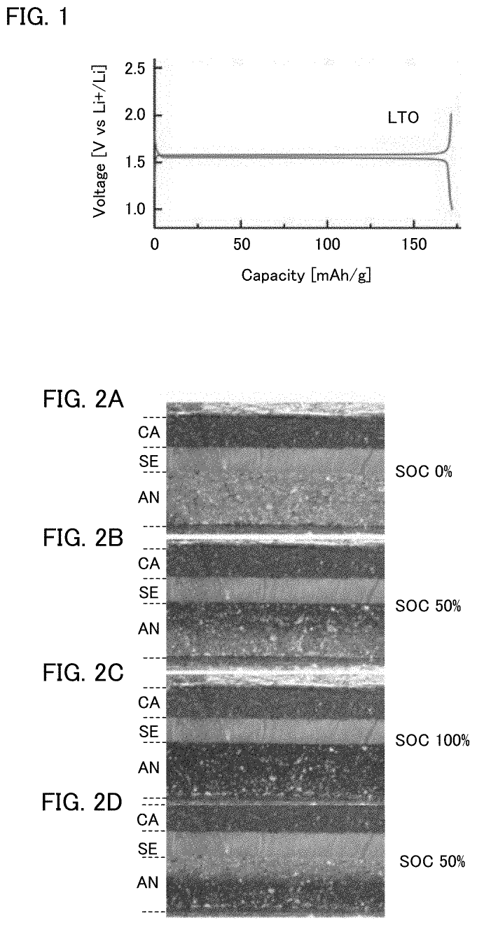

The lithium titanate has advantages such that the expansion and contraction due to charge and discharge do not occur, the chemical stability is high since it is an oxide, and excellent electron conductivity is exhibited in the charged state. Meanwhile, in the lithium titanate, the ratio of the plateau region occupied in the charge and discharge curve is large. FIG. 1 is charge and discharge curves of a half cell using Li₄Ti₅O₁₂ (LTO) as a working electrode, and a Li foil as a counter electrode. As shown in FIG. 1, in the LTO, the ratio of the plateau region occupancy is large at the time of both Li intercalation (when the all solid state battery is charged) and Li desorption (when the all solid state battery is discharged). Incidentally, the potential of the LTO decreases at the time of Li intercalation (when the all solid state battery is charged), and the potential of the LTO increases at the time of Li desorption (when the all solid state battery is discharged).

When the ratio of the plateau region occupied in the charge and discharge curves is large, the electrode reactions tend to deviate in the thickness direction of the anode active material layer. FIGS. 2A to 2D are the schematic cross-sectional views illustrating the state changes of the anode active material layer containing Li₄Ti₅O₁₂ (LTO) in the charged state. First, the all solid state battery shown in FIG. 2A includes layers in the order of an anode active material layer (AN), a solid electrolyte layer (SE), and a cathode active material layer (CA) along with the thickness direction. As shown in FIG. 2A, when SOC (State of Charge) is 0%, the color of the anode active material layer (AN) is uniform in the thickness direction.

Next, as shown in FIG. 2B, when SOC is 50%, the color of the anode active material layer (AN) in the solid electrolyte layer (SE) side region is dark. This shows that Li is intercalated to LTO that is positioned in the SE side. Meanwhile, when SOC is 50%, the color of the anode active material layer (AN) in the opposite side of the solid electrolyte layer (SE) region is equivalent color to that of FIG. 2A. This shows that Li is not intercalated to LTO that is positioned in the opposite side of SE. Next, as shown in FIG. 2C, when SOC is 100%, the color of the anode active material layer (AN) is uniformly dark in the thickness direction. This shows that Li is intercalated to whole LTO included in the anode active material layer (AN).

Next, when the battery is discharged from SOC 100% to SOC 50%, as shown in FIG. 2D, the color of the anode active material layer (AN) in the solid electrolyte layer (SE) side region is light. This shows that Li is desorbed from LTO that is positioned in SE side. Meanwhile, when SOC is 50%, the color of the anode active material layer (AN) in the opposite side of the solid electrolyte layer (SE) side region is equivalent color to that of FIG. 2C. This shows that Li is not desorbed from LTO that is positioned in the opposite side of SE.

As shown in FIGS. 2A to 2D, the reaction of the anode active material (LTO) and Li easily occurs in the region of the anode active material layer (AN) close to the solid electrolyte layer (SE), and does not easily occur in the region of the anode active material layer (AN) far from the solid electrolyte layer (SE). For this reason, when SOC is low, influence of the ion conduction resistance in the thickness direction is little, but when SOC is high, influence of the ion conduction resistance in the thickness direction is large. As a result, electrode reactions tend to deviate in the thickness direction of the anode active material layer.

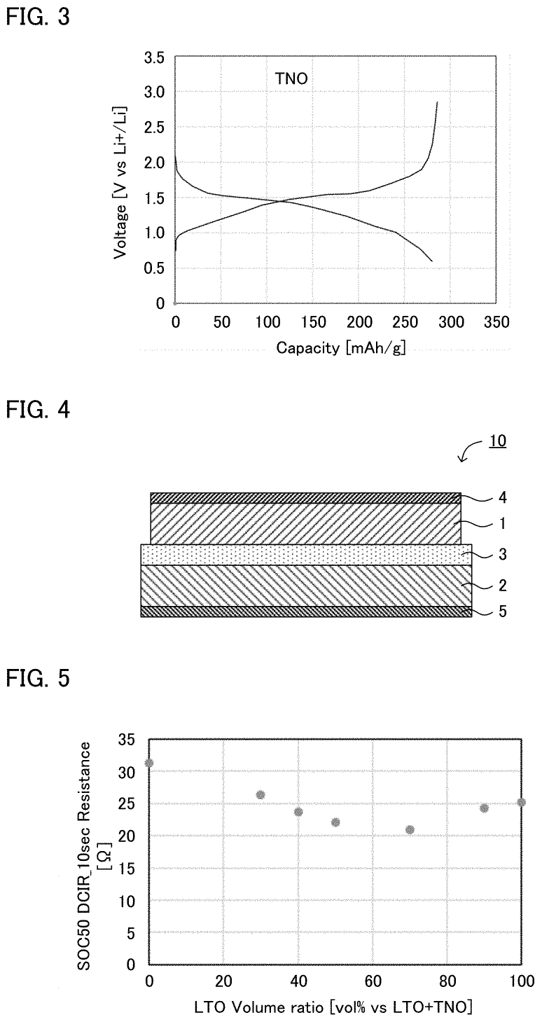

In contrast, in the present disclosure, the first anode active material (lithium titanate) is used together with the second anode active material (such as niobium-titanium oxide) of which ratio of the plateau region occupancy is smaller than that of the first anode active material. FIG. 3 is charge and discharge curves of a half cell using TiNb₂O₇ (TNO) as a working electrode, and a Li foil as a counter electrode.

As shown in FIG. 3, the plateau region occupied in TNO is smaller than that of LTO. For this reason, in the initial stage of Li intercalation (when the all solid state battery is charged), Li is intercalated to TNO at higher potential than that of LTO. As a result, in the region of the anode active material layer (AN) far from the solid electrolyte layer (SE), TNO reacts more rapidly than LTO, and thereby the deviation of electrode reactions in the thickness direction may be mitigated. As a result, the resistance at the time of charging may be reduced. Also, in the initial stage of Li desorption (when the all solid state battery is discharged), Li is desorbed from TNO at lower potential than that of LTO. As a result, in the region of the anode active material layer (AN) far from the solid electrolyte layer (SE), TNO reacts more rapidly than LTO, and thereby the deviation of electrode reactions in the thickness direction may be mitigated. As a result, the resistance at the time of discharging may be reduced. In this manner, in the present disclosure, the anode active material that is the lithium titanate is used together with the specified second anode active material, and thus the anode active material layer with low resistance may be obtained.

The anode active material layer in the present disclosure comprises at least a first anode active material and a second anode active material as the anode active material. The anode active material layer may further contain at least one of a solid electrolyte, a conductive material, and a binder.

1. Second Anode Active Material

First, a second anode active material will be explained. In the second anode active material, when a discharge capacity at a potential of 1.0 V vs Li⁺/Li or more and 2.0 V vs Li⁺/Li or less signifies 100% discharge capacity, and when P₁ designates an average potential in a capacity of 0% or more and 50% or less of the 100% discharge capacity, and P₂ designates an average potential in a capacity of 50% or more and 100% or less of the 100% discharge capacity, a difference between the P₂ and the P₁ is usually 0.1 V or more. Incidentally, since the potential of the second anode active material in the all solid state battery increases due to discharging, P₂ is usually larger than P₁.

P₁ and P₂ can be obtained from the following method. First, a half cell including a working electrode containing the second anode active material, a solid electrolyte layer, and a counter electrode that is a Li foil, is prepared. Incidentally, the working electrode may contain at least one of a solid electrolyte and a conductive material as required. Next, constant current (CC) discharge at 1/10 C is conducted to the half cell to intercalate Li in the amount equivalent to SOC 100%, to the second anode active material. After that, CC charge at 1/10 C is conducted to the half cell to desorb Li from the second anode active material. On this occasion, capacity at the potential of 1.0 V vs Li⁺/Li or more and 2.0 V vs Li⁺/Li or less is measured so as to obtain 100% discharge capacity. Next, an average potential P₁ in the capacity of 0% or more and 50% or less of the 100% discharge capacity, and an average potential P₂ in the capacity of 50% or more and 100% or less of the 100% discharge capacity are obtained from Li desorption curve.

The difference between P₂ and P₁ may be 0.2 V or more, may be 0.3 V or more, and may be 0.4 V or more. Incidentally, the difference between P₂ and P₁ in the TNO shown in FIG. 3 is 0.3 V. Also, P₁ is preferably lower than the discharge reaction potential (plateau potential) of the first anode active material. P₁ is, for example, smaller than 1.5 V vs Li⁺/Li, and may be 1.45 V vs Li⁺/Li or less. Also, P₂ may be higher than the discharge reaction potential (plateau potential) of the first anode active material. P₂ is, for example, larger than 1.5 V vs Li⁺/Li, and may be 1.55 V vs Li⁺/Li or more.

Also, in the second anode active material, when a charge capacity at a potential of 2.0 V vs Li⁺/Li or less and 1.0 V vs Li⁺/Li or more signifies 100% charge capacity, and when P₃ designates an average potential in a capacity of 0% or more and 50% or less of the 100% charge capacity, and P₄ designates an average potential in a capacity of 50% or more and 100% or less of the 100% charge capacity, a difference between the P₃ and the P₄ may be 0.1 V or more. Incidentally, since the potential of the second anode active material in the all solid state battery decreases due to charging, P₃ is usually larger than P₄.

P₃ and P₄ can be obtained from the following method. That is, a half cell is prepared in the same manner as above, and the cell is CC discharged at 1/10 C to intercalate Li to the second anode active material. On this occasion, capacity at the potential of 2.0 V vs Li⁺/Li or less and 1.0 V vs Li⁺/Li or more is measured so as to obtain 100% charge capacity. Next, an average potential P₃ in the capacity of 0% or more and 50% or less of the 100% charge capacity, and an average potential P₄ in the capacity of 50% or more and 100% or less of the 100% charge capacity are obtained from Li intercalation curve.

The difference between P₃ and P₄ may be 0.2 V or more, may be 0.3 V or more, and may be 0.4 V or more. Also, P₃ is preferably higher than the charge reaction potential (plateau potential) of the first anode active material. P₃ is, for example, larger than 1.5 V vs Li⁺/Li, and may be 1.55 V vs Li⁺/Li or more. P₄ may be lower than the charge reaction potential (plateau potential) of the first anode active material. P₄ is, for example, smaller than 1.5 V vs Li⁺/Li, and may be 1.45 V vs Li⁺/Li or less.

The discharge capacity of the second anode active material at a potential of 1.4 V vs Li⁺/Li or more and 2.0 V vs Li⁺/Li or less is, for example, 100 mAh/g or more. This discharge capacity can be obtained from the following method. That is, a half cell is prepared in the same manner as above, and Li in the equivalent amount of SOC 100% is intercalated to the second anode active material at 1/10 C. After that, CC charge at 1/10 C is conducted to the half cell to desorb Li from the second anode active material. On this occasion, the capacity at the potential of 1.4 V vs Li⁺/Li or more and 2.0 V vs Li⁺/Li or less is measured so as to obtain the discharge capacity. The discharge capacity of the second anode active material at a potential of 1.4 V vs Li⁺/Li or more and 2.0 V vs Li⁺/Li or less may be 120 mAh/g or more, and may be 140 mAh/g or more.

The charge capacity of the second anode active material at a potential of 2.0 V vs Li⁺/Li or less and 1.4 V vs Li⁺/Li or more may be 100 mAh/g or more. This charge capacity can be obtained from the following method. That is, a half cell is prepared in the same manner as above, and the cell is CC discharged at 1/10 C to intercalate Li to the second anode active material. On this occasion, the capacity at the potential of 2.0 V vs Li⁺/Li or less and 1.4 V vs Li⁺/Li or more is measured so as to obtain the charge capacity. The charge capacity of the second anode active material at a potential of 2.0 V vs Li⁺/Li or less and 1.4 V vs Li⁺/Li or more may be 120 mAh/g or more and may be 140 mAh/g or more.

The discharge reaction potential and the charge reaction potential of the second anode active material are not particularly limited, and examples thereof are respectively 1.0 V vs Li⁺/Li or more and 2.0 V vs Li⁺/Li or less.

The second anode active material preferably contains a metal element and an oxygen element; in other words, it is preferably a metal oxide. The reason therefor is that the metal oxide has high chemical stability. Examples of the metal element included in the metal oxide may include Nb, Ti and W. The metal oxide may contain just one kind of the above metal element, and may contain two kinds or more thereof.

Examples of the second anode active material may include a niobium-titanium oxide. The niobium-titanium oxide is a compound containing Nb, Ti and O. Examples of the niobium-titanium oxide may include TiNb₂O₇ and Ti₂Nb₁₀O₂₉. Also, examples of the second anode active material may include a niobium-tungsten oxide. The niobium-tungsten oxide is a compound containing Nb, W and O. Examples of the niobium-tungsten oxide may include Nb₂WO₈, Nb₂W₁₅O₅₀, Nb₄W₇O₃₁, Nb₈W₉O₄₇, Nb₁₄W₃O₄₄, Nb₁₆W₅O₅₅ and Nb₁₈W₁₆O₉₃.

The average particle size (D₅₀) of the second anode active material is, for example, 10 nm or more, and may be 100 nm or more. Meanwhile, the average particle size (D₅₀) of the second anode active material is, for example, 50 μm or less, and may be 20 μm or less. The average particle size (D₅₀) may be calculated from, for example, a measurement with a laser diffraction particle distribution meter or a scanning electron microscope (SEM).

2. First Anode Active Material

Next, the first anode active material will be explained. The first anode active material is a lithium titanate. The lithium titanate is a compound containing Li, Ti and O.

In the first anode active material, when a discharge capacity at a potential of 1.0 V vs Li⁺/Li or more and 2.0 V vs Li⁺/Li or less signifies 100% discharge capacity, and when P′1 designates an average potential in a capacity of 0% or more and 50% or less of the 100% discharge capacity, and P′₂ designates an average potential in a capacity of 50% or more and 100% or less of the 100% discharge capacity, a difference between the P′₂ and the P′₁ may be less than 0.1 V. P′₁ and P′₂ can be obtained in the same manner as for the above described P₁ and P₂ in the second anode active material.

In the first anode active material, when a charge capacity at a potential of 2.0 V vs Li⁺/Li or less and 1.0 V vs Li⁺/Li or more signifies 100% charge capacity, and when P′₃ designates an average potential in a capacity of 0% or more and 50% or less of the 100% charge capacity, and P′₄ designates an average potential in a capacity of 50% or more and 100% or less of the 100% charge capacity, a difference between the P′₃ and the P′₄ may be less than 0.1 V. P′₃ and P′₄ can be obtained in the same manner as for the above described P₃ and P₄ in the second anode active material.

The discharge capacity of the first anode active material at a potential of 1.4 V vs Li⁺/Li or more and 2.0 V vs Li⁺/Li or less is preferably 100 mAh/g or more. Likewise, the charge capacity of the first anode active material at a potential of 2.0 V vs Li⁺/Li or less and 1.4 V vs Li⁺/Li or more is preferably 100 mAh/g or more. The measurement methods for the discharge capacity and the charge capacity are the same as the measurement methods for the discharge capacity and the charge capacity in the second anode active material described above.

The discharge reaction potential and the charge reaction potential of the first anode active material are not particularly limited, and examples thereof are respectively 1.0 V vs Li⁺/Li or more and 2.0 V vs Li⁺/Li or less.

Specific examples of the first anode active material may include Li₄Ti₅O₁₂, Li₄TiO₄, Li₂TiO₃ and Li₂Ti₃O₇. Examples of the shape of the first anode active material may include a granular shape. The average particle size (D₅₀) of the first anode active material is, for example, 10 nm or more, and may be 100 nm or more. Meanwhile, the average particle size (D₅₀) of the first anode active material is, for example, 50 μm or less, and may be 20 μm or less. The average particle size (D₅₀) may be calculated from, for example, a measurement with a laser diffraction particle distribution meter or a scanning electron microscope (SEM).

3. Anode Active Material Layer

The anode active material layer in the present disclosure contains the first anode active material and the second anode active material. The anode active material layer may contain just the first anode active material and the second anode active material as the anode active material, and may contain an additional anode active material. The proportion of the total of the first anode active material and the second anode active material with respect to all the anode active materials included in the anode active material layer is, for example, 50 volume % or more, may be 70 volume % or more, and may be 90 volume % or more.

Also, the proportion of the first anode active material with respect to the total of the first anode active material and the second anode active material is usually 40 volume % or more, may be 50 volume % or more, and may be 60 volume % or more. Meanwhile, the proportion of the first anode active material with respect to the total of the first anode active material and the second anode active material is usually less than 100 volume %, may be 99 volume % or less, and may be 90 volume % or less. There is a possibility that the resistance may not be sufficiently reduced both of when the proportion of the first anode active material is too little and too much. Also, it is preferable that the first anode active material and the second anode active material are respectively dispersed in the anode active material layer uniformly.

The proportion of the anode active material in the anode active material layer is, for example, 30 volume % or more, and may be 50 volume % or more. If the proportion of the anode active material is too little, there is a possibility that volume energy density may not be improved. Meanwhile, the proportion of the anode active material in the anode active material layer is, for example, 80 volume % or less. If the proportion of the anode active material is too much, there is a possibility that excellent electron conducting path and ion conducting path may not be formed.

It is preferable that the anode active material layer contains a solid electrolyte. The reason therefor is to form excellent ion conducting path. Examples of the solid electrolyte may include an inorganic solid electrolyte such as a sulfide solid electrolyte, an oxide solid electrolyte, a nitride solid electrolyte, and a halide solid electrolyte.

Examples of the sulfide solid electrolyte may include a solid electrolyte containing a Li element, an X element (X is at least one kind of P, As, Sb, Si, Ge, Sn, B, Al, Ga, and In), and a S element. Also, the sulfide solid electrolyte may further contain at least one of an O element and a halogen element. Examples of the halogen element may include a F element, a Cl element, a Br element, and an I element. The sulfide solid electrolyte may be glass (amorphous), and may be a glass ceramic. Examples of the sulfide solid electrolyte may include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂.

The anode active material layer may contain just the inorganic solid electrolyte as the solid electrolyte. Also, the anode active material layer may or may not contain a liquid electrolyte (electrolyte solution). Also, the anode active material layer may or may not contain a gel electrolyte. Also, the anode active material layer may or may not contain a polymer electrolyte.

It is preferable that the anode active material layer contains a conductive material. Examples of the conductive material may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF).

The anode active material layer may contain a binder. Examples of the binder may include a fluoride-based binder, a polyimide-based binder and a rubber-based binder. Also, the thickness of the anode active material layer is, for example, 0.1 μm or more and 1000 μm or less. The anode active material layer is used in an all solid state battery. Details of the all solid state battery will be described later.

B. All Solid State Battery

FIG. 4 is a schematic cross-sectional view exemplifying the all solid state battery in the present disclosure. All solid state battery 10 illustrated in FIG. 4 includes cathode active material layer 1, anode active material layer 2, solid electrolyte layer 3 arranged between cathode active material layer 1 and anode active material layer 2, cathode current collector 4 for collecting currents of cathode active material layer 1, and anode current collector 5 for collecting currents of anode active material layer 2. The anode active material layer 2 is the layer described in “A. Anode active material layer” above.

According to the present disclosure, usage of the above described anode active material layer allows the all solid state battery to have low resistance.

1. Anode Active Material Layer

The anode active material layer in the present disclosure is in the same contents as those described in “A. Anode active material layer” above; thus, the descriptions herein are omitted.

2. Cathode Active Material Layer

The cathode active material layer in the present disclosure is a layer containing at least a cathode active material. Also, the cathode active material layer may contain at least one of a conductive material, a solid electrolyte, and a binder, as required.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄, Li₄Ti₅O₁₂ and Li(Ni_{0.5}Mn_{1.5})O₄; and an olivine type active material such as LiFePO₄, LiMnPO₄, LiNiPO₄, and LiCoPO₄.

A protective layer containing Li-ion conductive oxide may be formed on the surface of the oxide active material. The reason therefor is to inhibit the reaction of the oxide active material and the solid electrolyte. Examples of the Li-ion conductive oxide may include LiNbO₃. The thickness of the protective layer is, for example, 1 nm or more and 30 nm or less. Also, as the cathode active material, for example, Li₂S can be used.

Examples of the shape of the cathode active material may include a granular shape. The average particle size (D₅₀) of the cathode active material is not particularly limited, and for example, it is 10 nm or more, and may be 100 nm or more. Meanwhile, the average particle size (D₅₀) of the cathode active material is, for example, 50 μm or less, and may be 20 μm or less.

Examples of the conductive material may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF).

The solid electrolyte and the binder to be used in the cathode active material layer are in the same contents as those described in “A. Anode active material layer” above; thus, the descriptions herein are omitted. The thickness of the cathode active material layer is, for example, 0.1 μm or more and 1000 μm or less.

3. Solid Electrolyte Layer

The solid electrolyte layer in the present disclosure is a layer arranged between the cathode active material layer and the anode active material layer, and contains at least a solid electrolyte. The solid electrolyte layer preferably contains a sulfide solid electrolyte as the solid electrolyte. Also, the solid electrolyte layer may contain a binder. The solid electrolyte and the binder to be used in the solid electrolyte layer are in the same contents as those described in “A. Anode active material layer” above; thus, the descriptions herein are omitted. The thickness of the solid electrolyte layer is, for example, 0.1 μm or more and 1000 μm or less.

4. All Solid State Battery

The all solid state battery in the present disclosure usually comprises a cathode current collector for collecting currents of the cathode active material layer and an anode current collector for collecting currents of the anode active material layer. Examples of the shape of the cathode current collector and the anode current collector may include a foil shape. Examples of the material for the cathode current collector may include SUS, aluminum, nickel, and carbon. Also, examples of the material for the anode current collector may include SUS, copper, nickel, and carbon.

The all solid state battery in the present disclosure comprises at least one of a power generating unit including a cathode active material layer, a solid electrolyte layer and an anode active material layer, and may comprise two or more of the unit. When the all solid state battery comprises a plurality of the power generating unit, they may be connected in parallel and may be connected in series. The all solid state battery in the present disclosure includes an outer package for storing the cathode current collector, the cathode active material layer, the solid electrolyte layer, the anode active material layer and the anode current collector. There are no particular limitations on the kind of the outer package, and examples thereof may include a laminate outer package.

The all solid state battery in the present disclosure may include a restraining jig that applies a restraining pressure along with the thickness direction of the cathode active material layer, the solid electrolyte layer and the anode active material layer. Excellent ion conducting path and electron conducting path may be formed by applying the restraining pressure. The restraining pressure is, for example, 0.1 MPa or more, may be 1 MPa or more, and may be 5 MPa or more. Meanwhile, the restraining pressure is, for example, 100 MPa or less, may be 50 MPa or less, and may be 20 MPa or less.

The all solid state battery in the present disclosure is typically an all solid lithium ion secondary battery. The application of the all solid state battery is not particularly limited, and examples thereof may include a power source for vehicles such as hybrid electric vehicles, battery electric vehicles, fuel cell electric vehicles and diesel powered automobiles. In particular, it is preferably used as a power source for driving hybrid electric vehicles and battery electric vehicles. Also, the all solid state battery in the present disclosure may be used as a power source for moving bodies other than vehicles (such as rail road transportation, vessel and airplane), and may be used as a power source for electronic products such as information processing equipment.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Anode>

As raw materials, Li₄Ti₅O₁₂ (LTO) particles, TiNb₂O₇ (TNO) particles, a sulfide solid electrolyte, a vapor grown carbon fiber, a PVdF-based binder and butyl butyrate were prepared and agitated by an ultrasonic dispersion device to obtain anode slurry. The volume ratio of each raw material in the anode slurry was LTO particles:TNO particles:sulfide solid electrolyte:vapor grown carbon fiber:PVdF-based binder=53.7:6.0:32.2:2.5:5.6.

Incidentally, the volume ratio of the LTO particles and the TNO particles was LTO particles:TNO particles=90:10. The obtained anode slurry was pasted on a Ni foil that was as an anode current collector by a blade method, and dried in the conditions of 100° C. on a hot plate for 30 minutes. Thereby, an anode including an anode current collector and an anode active material layer was obtained.

<Production of Cathode>

As raw materials, LiNi_{1/3}Co_{1/3}Mn₁O₂ (cathode active material), a sulfide solid electrolyte, vapor grown carbon fiber, a PVdF-based binder and butyl butyrate were prepared, and agitated by an ultrasonic dispersion device to obtain cathode slurry. The volume ratio of each raw material in the cathode slurry was cathode active material:sulfide solid electrolyte:vapor grown carbon fiber:PVdF-based binder=66.5:28.5:3.7:1.4. The obtained cathode slurry was pasted on an Al foil that was as a cathode current collector by a blade method, and dried in the conditions of 100° C. on a hot plate for 30 minutes. Thereby, a cathode including a cathode current collector and a cathode active material layer was obtained.

<Production of Solid Electrolyte Layer>

As raw materials, a sulfide solid electrolyte, a PVdF-based binder and butyl butyrate were prepared and agitated by an ultrasonic dispersion device to obtain solid electrolyte slurry. The weight ratio of each raw material in the solid electrolyte slurry was sulfide solid electrolyte:PVdF-based binder=99.4:0.4. The obtained solid electrolyte slurry was pasted on an Al foil by a blade method and dried in the conditions of 100° C. on a hot plate for 30 minutes. Thereby, a solid electrolyte layer on the Al foil (a solid electrolyte layer peelable from the Al foil) was obtained.

<Production of all Solid State Battery>

The cathode active material layer in the cathode and the solid electrolyte layer were faced to each other and pressed with a roll pressing machine in the conditions of the pressing pressure of 50 kN/cm and the temperature of 160° C. After that, the Al foil was peeled off from the solid electrolyte layer and punched out into the size of 1 cm² to obtain a cathode layered body.

Next, the anode active material layer in the anode and the solid electrolyte layer were faced to each other and pressed with a roll pressing machine in the conditions of the pressing pressure of 50 kN/cm and the temperature of 160° C. After that, the Al foil was peeled off from the solid electrolyte layer to obtain an anode layered body. In addition, the solid electrolyte layer in the anode layered body and the other solid electrolyte layer were faced to each other and temporary pressed with a plane uniaxial pressing machine in the conditions of the pressing pressure of 100 MPa and the temperature of 25° C. After that, the Al foil was peeled off from the solid electrolyte layer and punched out into the size of 1.08 cm² to obtain an anode structure body including a solid electrolyte layer and an anode layered body.

The solid electrolyte layer in the cathode layered body and the solid electrolyte layer in the anode structure body were faced to each other and pressed with a plane uniaxial pressing machine in the conditions of the pressing pressure of 200 MPa and the temperature of 120° C. Thereby, an all solid state battery was obtained.

### Example 2

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=41.8:17.9:32.2:2.5:5.6. Incidentally, the volume ratio of the LTO particles and the TNO particles was LTO particles:TNO particles=70:30.

### Example 3

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=29.85: 29.85:32.2:2.5:5.6. Incidentally, the volume ratio of the LTO particles and the TNO particles was LTO particles:TNO particles=50:50.

### Example 4

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=23.9:35.8:32.2:2.5:5.6. Incidentally, the volume ratio of the LTO particles and the TNO particles were LTO particles:TNO particles=40:60.

### Comparative Example 1

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=59.7:0:32.2:2.5:5.6. Incidentally, the volume ratio of the LTO particles and the TNO particles was LTO particles:TNO particles=100:0.

### Comparative Example 2

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=0:59.7:32.2:2.5:5.6. Incidentally, the volume ratio of the LTO particles and the TNO particles was LTO particles:TNO particles=0:100.

### Comparative Example 3

An all solid state battery was obtained in the same manner as in Example 1, except that the volume ratio of each raw material in the anode slurry was changed to LTO particles:TNO particles:sulfide solid electrolyte:vapor grown carbon fiber:PVdF-based binder=17.9:41.8: 32.2:2.5:5.6. Incidentally, the volume ratio of the LTO particles and the TNO particles was LTO particles:TNO particles=30:70.

[Evaluation]

The all solid state batteries obtained in Examples 1 to 4 and Comparative Examples 1 to 3 were respectively sandwiched between two pieces of restraining plate and restrained at the restraining pressure of 5 MPa with a fastener. After that, the batteries were respectively constant-current (CC) charged at 1/10 C until 2.9 V, and then constant-voltage (CV) charged at 2.9 V until the termination current of 1/100 C. Further, the batteries were respectively CC-discharged at 1/10 C until 1.5 V, and then CC-discharged at 1.5 V until the termination current of 1/100 C. The CC-discharge capacity and the CV-discharge capacity until 1.5 V were added up to obtain the discharge capacity.

Also, to the restrained all solid state batteries, an initial charge (CC-charge) was respectively conducted at 1/10 C so that the discharge capacity became 50%, and thereby the SOC was adjusted. Using the all solid state batteries after the adjustment, current of 8 mA/cm² was flowed for 10 seconds, and the voltage changes before and after that were divided by the current value to obtain the resistance. The results are shown in Table 1 and FIG. 5.

TABLE 1

| | Anode | | |
|---|---|---|---|
| | active material | | |
| | LTO | TNO | Resistance |
| | [vol %] | [vol %] | [Ω/cm²] |
| Comparative | 100 | 0 | 25.2 |
| Example 1 | | | |
| Example 1 | 90 | 10 | 24.3 |
| Example 2 | 70 | 30 | 20.9 |
| Example 3 | 50 | 50 | 22.1 |
| Example 4 | 40 | 60 | 23.7 |
| Comparative | 30 | 70 | 26.4 |
| Example 3 | | | |
| Comparative | 0 | 100 | 31.3 |
| Example 2 | | | |

As shown in Table 1 and FIG. 5, it was confirmed that the resistance of Examples 1 to 4 was respectively lower than that of Comparative Example 1 (only with LTO particles). Here, since the resistance of Comparative Example 2 (only with TNO particles) was higher than that of Comparative Example 1 (only with LTO particles), it was predicted that the resistance would increase more along with the proportion of the TNO particles increased; however, surprisingly, it was confirmed that the resistance of Examples 1 to 4 was respectively lower than that of Comparative Example 1. Also, in Comparative Example 3, the proportion of the TNO particles was too much, and thus the resistance thereof was presumably higher than that of Comparative Example 1. In this manner, the resistance was reduced when the LTO particles were used together with the TNO particles, and further, when the proportion of the LTO particles was in the specified range.

### REFERENCE SIGNS LIST

1 cathode active material layer
2 anode active material layer
3 solid electrolyte layer
4 cathode current collector
5 anode current collector
10 all solid state battery

What is claimed is:

1. An anode active material layer to be used in an all solid state battery, the anode active material layer comprises:
a first anode active material and a second anode active material; wherein
the first anode active material is a lithium titanate;
in the second anode active material, when a discharge capacity at a potential of 1.0 V vs Li⁺/Li or more and 2.0 V vs Li⁺/Li or less signifies 100% discharge capacity, and when P₁ designates an average potential in a capacity of 0% or more and 50% or less of the 100% discharge capacity, and P₂ designates an average potential in a capacity of 50% or more and 100% or less of the 100% discharge capacity, a difference between the P₂ and the P₁ is 0.1 V or more; and
a proportion of the first anode active material with respect to a total of the first anode active material and the second anode active material is 40 volume % or more.

2. The anode active material layer according to claim 1, wherein a discharge capacity of the second anode active material at a potential of 1.4 V vs Li⁺/Li or more and 2.0 V vs Li⁺/Li or less is 100 mAh/g or more.

3. The anode active material layer according to claim 1, wherein the second anode active material is at least one of a niobium-titanium oxide and a niobium-tungsten oxide.

4. The anode active material layer according to claim 1, wherein the proportion of the first anode active material with respect to the total of the first anode active material and the second anode active material is 90 volume % or less.

5. An all solid state battery comprising a cathode active material layer, an anode active material layer, and a solid electrolyte layer arranged between the cathode active material layer and the anode active material layer; wherein
the anode active material layer is the anode active material layer according to claim 1.
